(19) United States
(12) Patent Application Publication
(10) Pub. No.: US 2006/0152685 A1
(43) Pub. Date: Jul. 13, 2006

(54) Optic projecting method and structure of rear projection TV for dual projecting system

(76) Inventors: Tsen-Hwang Lin, Dallas, TX (US); Johnson Jang-Shen Lin, Dr. Plano, TX (US)

Correspondence Address: BACON & THOMAS, PLLC, 625 SLATERS LANE, FOURTH FLOOR, ALEXANDRIA, VA, 22314, US

(21) Appl. No.: 11/032,069

(22) Filed: Jan. 11, 2005

(51) Int. Cl. G03B 21/22

(52) U.S. Cl. 353/74

(57) ABSTRACT

The present invention concerns an optic projecting technique for a projecting system comprising a housing and a projector unit, the projecting system comprises a housing and a projector unit, wherein the housing is provided with a display screen and a plurality of optic elements in the housing; the system is characterized in that: the projector unit is placed on the back of the housing in favor of detachment and displacement; when the projector unit projects optic images into the housing, the images from the projector are reflected by the optic elements and projected to the rear side of the display screen; when the projector unit is placed outside of the housing, it directly projects the optic images to the display screen at a suitable distance away, thus a dual projecting system for rear projection and front projection can be is formed.

### BACKGROUND OF THE INVENTION

1. Field of the Invention

The present invention is related to an optic projecting technique for a projecting system, and especially to a dual projecting system which is comprised of a housing and a projector unit, the projector unit is placed on the back of the housing in favor of detachment and displacement, by this, the dual projecting system of which the projector unit is able to be placed in or outside of the housing for rear projection and front projection can be realized.

2. Description of the Prior Art

Normally, a set of front projection (FP) AV equipment mainly has image signals connected to a projector which converts the image signals into optic images and projects, and a display screen at a predetermined distance away presents the images projected by the projector, thereby an effect of presenting images in a large screen can be achieved through optical amplifying the images.

In practical use of a set of front projection (FP) AV equipment, the projector and the display screen must have any article that can impede image projecting therebetween removed, the images can thus be perfectly presented in the display screen; this has quite a lot of limitations in use. Thereby, there are rear projection (RP) TVs with a projector assembled in its housing in the markets, they mainly are provided each on its front side with a display screen to have the optic images projected from the projector reflected and projected to the rear side of the display screen to present the images; they can have the effect of having displayed images of larger sizes than those made on a picture tube and a liquid crystal or plasma TV.

As compared with a set of front projection (FP) AV equipment, a rear projection (RP) TV has all its electric circuits integrated in a housing, the projecting path of the optic images is also limited to the inside of the housing, it can get better effect of image presenting, the displaying area in projecting images of it is limited by the volume of the rear projection (RP) TV itself; that is, the larger the displaying area in projecting images is, the larger the volume of the rear projection (RP) TV shall be. Thereby in the markets, rear projection (RP) TVs and front projection (FP) AV equipments gradually form extremely evident difference. By considering residential spaces of normal families, the families mostly select rear projection (RP) TVs; while people preferably select front projection (FP) AV equipments for the places such as offices, meeting rooms etc.

Actually, no matter it is a rear projection (RP) TV or a set of front projection (FP) AV equipment, its key element is the most expensive main part, and is composed of a projector unit. Namely, when the projector unit is provided in a housing with a fixed size for projecting images to project to the rear side of a display screen via reflection of optic elements, a rear projection (RP) TV is formed; when the projector unit directly projects optic images to a display screen at a suitable distance away, a set of front projection (FP) AV equipment is formed.

Therefore, if the projector unit in the rear projection (RP) TV is designed to be detachable, and the projector unit is used to directly projects optic images to a display screen at a suitable distance away, the rear projection (RP) TV can become a dual projecting system having both a rear projection (RP) TV and a set of front projection (FP) AV equipment.

### SUMMARY OF THE INVENTION

Particularly, the dual projecting system of the present invention is comprised of a housing and a projector unit, wherein the housing is provided at least with a display screen and a plurality of optic elements provided in the housing; the present invention is characterized in that: the projector unit is placed on the back of the housing in favor of detachment and displacement, when the projector unit projects optic images into the housing, the images from the projector are reflected by the optic elements and projected to the rear side of the display screen; when the projector unit is placed outside of the housing, it directly projects the optic images to the display screen at a suitable distance away, thus the dual projecting system for rear projection and front projection can be is formed.

In the above stated dual projecting system of the present invention, the housing is integrally formed, or formed from a plurality of plates. Wherein the housing being formed from the plurality of plates further comprises: a panel, two lateral plates respectively provided on the two lateral sides of the panel, a back plate located on the upper area of the back side of the housing and declined downwards, a partition plate located on the lower area of the back plate and vertically extending downwards as well as a bottom plate provided on the bottom, this embodiment is characterized in that: the joints of these plates are connected and fixed by means of detachable engaging members, they can endue the housing with a fixed shape by engaging, and can have these plates stacked one over another after detaching in favor of storing.

The dual projecting system of the present invention not only can have the advantage of a rear projection (RP) TV and a set of front projection (FP) AV equipment, but also can have the projector unit of the present invention detached in comparison with the situation that the projector unit of a conventional rear projection (RP) TV is fixed in a housing; the present invention can largely reduce cost in production, assembling as well as maintenance.

In addition to these, the above structure having a housing- and a projector unit designed to be detachable and assemblable, for manufacturers, they can have a strategy of sale to enter the markets through a path of “DIY” commodities (such as: provided by IKEA company), this has several advantages, i.e., this not only is benefit to lowering the costs of transporting and stock, but also can have a different path of marketing from that of the traditional markets of household electrical appliances, thereby competition in prices can be provided for customers.

Another feature of the present invention is, when the projector unit is placed in the housing, it forms a rear projection (RP) TV, the optical method of it is using the nature that the projecting light will not mutually influence, they can be crossed with one another, and make the path of a single reflection or one of multiple time reflections parallel to a display screen, and then be reflected to the rear side of the display screen via other optic elements. Hence the present invention is characterized in that: during the process that the projector unit projects optic images to the rear side of the display screen, there are at least a step of reflecting the optic images down from above or upwards from below, and then the upper or lower corresponding optic elements reflect the optic images directly or indirectly to the rear side of the display screen.

The structure in the above stated method of the present invention is characterized in that: the projector unit is provided on the back side of the housing, the housing is provided on the upper area or the lower area of the display screen with an optic element to receive and reflect the optic images projected from the projector unit.

The structure in the above stated method of the present invention is also characterized in that: the projector unit is provided on the back side of the housing, after the projector unit projects optic images to a first optic element on the upper area or the lower area of the display screen, the first optic element reflects the optic images down from above or upwards from below to a second optic element on the upper area or the lower area of the display screen, the second optic element reflects the optic images to a third optic element on the back side of the housing, the optic images can thus be projected to the back side of the display screen provided on the housing.

The above stated measure to provide the projector unit of the present invention on the back side of the housing can form a rear projection (RP) TV, wherein the housing of the rear projection (RP) TV comprises:

a display screen provided on a front side of the housing;

a first optic element provided on an upper area or a lower area of the display screen in the housing;

a second optic element provided in opposition to the first optic element in the housing on the upper area or the lower area of the display screen; and

a third optic element provided on the back side of the housing.

The optic images projected by the projector unit are reflected sequentially by the first, the second and the third optic elements in the housing, and then are projected to the rear side of the display screen.

In the method and structure as stated above, the housing is further provided on an upper area or a lower area of the back side thereof with a receiving cartridge for receiving the projector unit in order to be convenient for detaching and assembling of the projector unit.

The present invention will be apparent in its structural combination and entire mode of operation after reading the detailed description of the preferred embodiment thereof in reference to the accompanying drawings.

### BRIEF DESCRIPTION OF THE DRAWINGS

FIG. 1 is a perspective view showing the appearance of a dual projecting system of the present invention;

FIG. 2 is an anatomic perspective view of a rear projection (RP) TV of the present invention;

FIG. 3 is a sectional schematic view showing the method and structure for optical projecting of the rear projection (RP) TV of the present invention.

### DETAILED DESCRIPTION OF THE PREFERRED EMBODIMENT

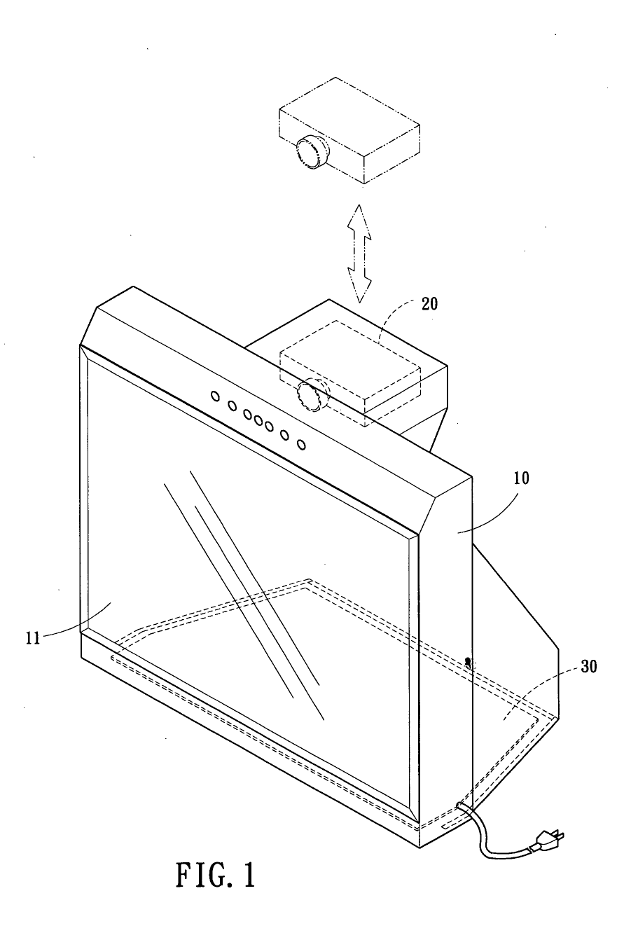

Referring to the embodiment FIG. 1, the dual projecting system of the present invention comprises a housing 10 and a projector unit 20, wherein the housing 10 is provided at least with a display screen 11 and a plurality of optic elements 30 provided in the housing 10; the present invention is characterized in that: the projector unit 20 is placed on the back of the housing 10 in favor of detachment and displacement, when the projector unit 20 projects optic images into the housing 10, the images are projected to the rear side of the display screen 11 by reflection of the optic elements 30; thus a rear projection (RP) TV is formed. When the projector unit 20 is placed outside of the housing 10, it directly projects the optic images to the display screen 11 at a suitable distance away (not shown), thereby a set of front projection (FP) AV equipment is formed.

The appearance of the housing 10 is similar to a normal rear projection (RP) TV; when the projector unit 20 is removed from the housing 10 and is moved to become the front projection (FP) AV equipment, another display screen is allocated for it, and even an indoor or outdoor wall of plain color (preferably of white color) can be used as a display screen; this is the mode of application of a set of normal front projection (FP) AV equipment, and no further narration is required here.

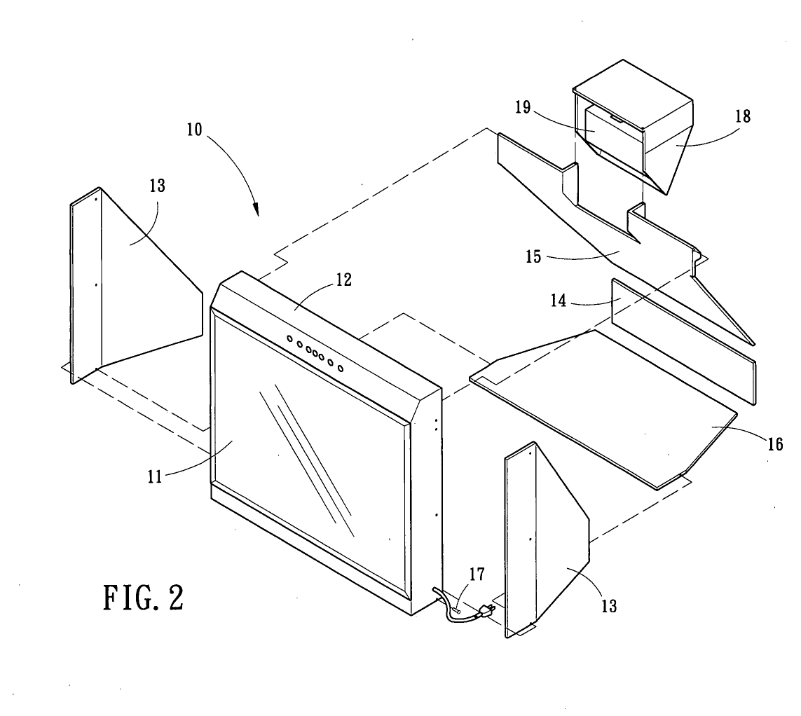

As shown in FIG. 2, in the above stated dual projecting system of the present invention the housing 10 is formed from a plurality of plates comprising: a panel 12, two lateral plates 13 respectively provided on the two lateral sides of the panel 12, a back plate 14 located on the upper area of the back side of the housing 10 and declined downwards, a partition plate 15 located on the lower area of the back plate 14 and vertically extending downwards as well as a bottom plate 16 provided on the bottom, this embodiment is characterized in that: the joints of these plates are connected and fixed by means of detachable engaging members 17, they can form by engaging the housing 10 with a fixed shape, and can have these plates stacked one over another after detaching in favor of storing.

The engaging members 17 depicted in the drawing are screws, capable of easily effecting detachment and engaging of the plates; when in practicing, engaging members or other connecting members needing no tool can also be used, alternatively, tenons and mortises can be directly provided on the plates; even the plates can be provided with pivotal connecting members such as hinges etc. in convenience of detaching and assembling of the housing 10.

Surely, in the present invention, the housing 10 can have other embodiments rather than is limited to the above stated forming from a plurality of plates; an example is that, after the housing 10 is integrally formed in a die, it can be mounted with a projector unit and a plurality of optic elements.

Additionally, in the dual projecting system of the present invention, the housing 10 is further provided on an upper area or a lower area of the back side thereof with a receiving cartridge 18 for receiving the projector unit in order to be convenient for detaching and assembling of the projector unit 20. When in practicing, the receiving cartridge 18 is provided with an opening for the convenience of taking the projector unit 20 out of the receiving cartridge 18; alternatively, the receiving cartridge 18 can be provided with an engaging structure separable from the housing 10, if it is desired to separate or fix the projector unit 20 from/to the housing 10, it needs only to detach or mount (fix) the receiving cartridge 18 from/to the housing 10, the projector unit 20 can be simultaneously detached and assembled.

In addition to this, the receiving cartridge 18 can be provided with insertion slots and a board interconnect mechanism 19 for signal connecting, they can be connected with the projector unit 20; when the projector unit 20 is inserted into the receiving cartridge 18, they can make fixing of its position and form signal connecting, this is benefit to fixing of the angle of optical projecting.

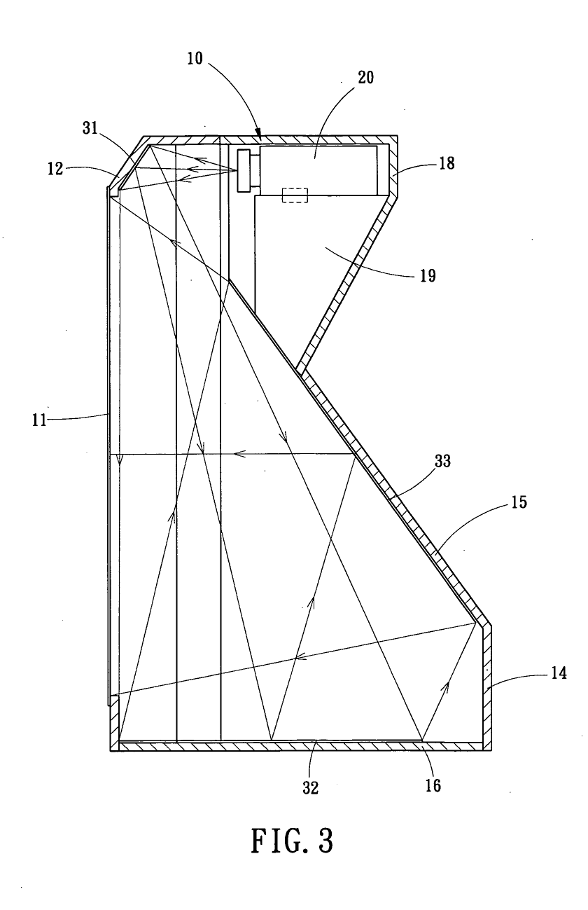

As shown in FIG. 3, the projector unit 20 of the present invention is mounted on the housing 10, thus a rear projection (RP) TV can be formed, the optical projecting method of the rear projection (RP) TV is using the nature that the projecting light will not mutually influence when they are crossed with one another and make the path of a single reflection or one of multiple time reflections parallel to a display screen, and then be reflected to the rear side of the display screen via optic elements.

Therefore, the structural combination of the present invention can include the housing 10 and the projector unit 20, the housing 10 at least has in the front of it a display screen 11, and has therein a plurality of optic elements 30 (including the following optic elements 31, 32 and 33) to reflect the images, it is characterized in that:

the projector unit 20 is provided on the back side of the housing 10, after the projector unit 20 projects optic images to a first optic element 31 on the upper area or the lower area of the display screen 11, the first optic element 31 reflects the optic images down from above or upwards from below to a second optic element 32 on the upper area or the lower area of the display screen 11, the second optic element 32 reflects the optic images to a third optic element 33 on the back side of the housing 10, the optic images can thus be projected to the back side of the display screen 11 by reflecting of the third optic element 33.

The above optic elements 31, 32 and 33 are mirrors with function of reflecting.

The above stated measure to provide the projector unit 20 of the present invention on the back side of the housing 10 can form a rear projection (RP) TV, wherein the housing 10 of the rear projection (RP) TV comprises:

a display screen 11 provided on a front side of the housing 10;

a first optic element 31 provided on an upper area or a lower area of the display screen 11 in the housing 10;

a second optic element 32 provided in opposition to the first optic element 31 in the housing 10 on the upper area or the lower area of the display screen 11; and

a third optic element 33 provided on the back side of the housing 10.

The optic images projected by the projector unit 20 are reflected sequentially by the first, the second and the third optic elements 31, 32 and 33 in the housing 10, and then are projected to the rear side of the display screen 11.

As shown in FIG. 3, the projector unit of the present invention is provided in the housing 10 to form a rear projection (RP) TV, the method of optical light projecting from the rear projection (RP) TV is characterized in that: during the process that the projector unit 20 projects optic images to the rear side of the display screen 11 of the housing 10, there are at least a step of reflecting the optic images down from above or upwards from below, and then the corresponding optic elements 31, 32 and 33 reflect the optic images directly or indirectly to the rear side of the display screen 11.

The structure of the rear projection (RP) TV in the above stated method is characterized in that: the projector unit 20 is provided on the back side of the housing 10, the housing 10 is provided on an upper area of the display screen 11 with the first optic element 31 to receive and reflect the optic images projected from the projector unit 20.

The above description and drawings of the embodiment given is only for illustrating the present invention, and not for giving any limitation to the scope of the present invention; it will be apparent to those skilled in this art that various modifications or changes without departing from the spirit of this invention in the method, structure and assembling etc. shall also fall within the scope of the appended claims.

1. A dual projecting system comprising a housing and a projector unit, wherein said housing is provided at least with a display screen and a plurality of optic elements provided in said housing; said system is characterized in that:
said projector unit is placed on a back of said housing in favor of detachment and displacement, when said projector unit is fixed on said back of said housing and projects optic images into said housing, said images are reflected by said optic elements and projected to a rear side of said display screen; when said projector unit is placed outside of said housing, it directly projects said optic images to said display screen at a predetermined distance away, thus a front projection is formed.

2. The dual projecting system as in claim 1, wherein: said housing is formed from a plurality of plates and comprises: a panel, two lateral plates respectively provided on the two lateral sides of said panel, a back plate located on an upper area of said back side of said housing and declined downwards, a partition plate located on a lower area of said back plate and vertically extending downwards as well as a bottom plate provided as a bottom of said housing.

3. The dual projecting system as in claim 2, wherein joints of said plates are connected and fixed by means of detachable engaging members, they endue said housing with a fixed shape by engaging, and have these plates stacked one over another after detaching in favor of storing.

4. The dual projecting system as in claim 2, wherein: said joints are connected with hinges.

5. The dual projecting system as in claim 2, wherein: said housing is integrally formed.

6. The dual projecting system as in claim 1, wherein: said housing is further provided on an upper area or a lower area of said back side thereof with a receiving cartridge for receiving said projector unit.

7. The dual projecting system as in claim 6, wherein: said receiving cartridge is provided with an opening for the convenience of detaching and assembling of said projector unit in said receiving cartridge.

8. The dual projecting system as in claim 6, wherein: said receiving cartridge is provided with insertion slots and pins for fixing position of said projector unit in insertion of said projector unit, and for signal connecting.

9. The dual projecting system as in claim 6, wherein: said receiving cartridge is provided with an engaging structure for fixing on or separating from said housing.

10. The dual projecting system as in claim 1, wherein: said optic elements are mirrors with function of reflecting.

11. An optical projecting method of a rear projection (RP) TV comprising a housing and a projector unit, wherein said housing is provided on the front thereof at least with a display screen and a plurality of optic elements in said housing for reflecting optic images; said rear projection TV is characterized in that:
said projector unit is provided on a back side of said housing, after said projector unit projects optic images to a first optic element on an upper area of said display screen, said first optic element reflects said optic images down from above to a second optic element on a lower area of said display screen, said second optic element reflects said optic images to a third optic element on said back side of said housing, said optic images is reflected by said third optic element and projected to a back side of said display screen.

12. An optical projecting method of a rear projection (RP) TV, comprising a housing and a projector unit, wherein said housing is provided on the front thereof at least with a display screen and a plurality of optic elements in said housing for reflecting optic images; said rear projection TV is characterized in that:
said projector unit is provided on a back side of said housing, after said projector unit projects optic images to a first optic element on a lower area of said display screen, said first optic element reflects said optic images upwards from below to a second optic element on a upper area of said display screen, said second optic element reflects said optic images to a third optic element on said back side of said housing, said optic images is reflected by said third optic element and projected to a back side of said display screen.

13. The structure of a rear projection (RP) TV comprising a housing and a projector unit and a plurality of optic elements, wherein said housing comprises:
a display screen provided on a front side of said housing;
a first optic element provided on an upper area or a lower area of said display screen in said housing;
a second optic element provided in opposition to said first optic element in said housing on said upper area or said lower area of said display screen; and
a third optic element provided on a back side of said housing;
optic images projected by said projector unit are reflected sequentially by said first, second and third optic elements in said housing, and then are projected to said rear side of said display screen.

14. An optical projecting method of a rear projection (RP) TV comprising a housing and a projector unit, wherein said housing is provided on the front thereof at least with a display screen and a plurality of optic elements in said housing for reflecting optic images; said method is characterized in that:
during a process that said projector unit projects optic images to a rear side of said display screen in said housing, there are at least a step of reflecting said optic images down from above or upwards from below, and then corresponding optic elements reflect said optic images directly or indirectly to said rear side of said display screen.

15. The structure of a rear projection (RP) TV comprising a housing and a projector unit, wherein said housing is provided on the front thereof at least with a display screen and a plurality of optic elements in said housing for reflecting optic images; said structure is characterized in that:
said projector unit is provided on a back side of said housing, said housing is provided on an upper area or a lower area of said display screen with a first optic element to receive and reflect optic images projected from said projector unit.

16. The structure of a rear projection (RP) TV comprising a housing and a projector unit, wherein said housing is provided on the front thereof at least with a display screen and a plurality of optic elements in said housing for reflecting optic images; said structure is characterized in that:
said housing is provided on a back side thereof with a receiving cartridge for receiving said projector unit.

17. The structure of a rear projection (RP) TV as in claim 16, wherein:
said receiving cartridge is provided with insertion slots and a board interconnect mechanism for signal connecting, for fixing position of said projector unit in insertion of said projector unit and for signal connecting.

18. The structure of a rear projection (RP) TV as in claim 16, wherein: said receiving cartridge is provided on an upper area of said housing.

19. The structure of a rear projection (RP) TV as in claim 16, wherein: said receiving cartridge is provided on a lower area of said housing.
